(19) United States
(12) Patent Application Publication
(10) Pub. No.: US 2021/0309798 A1
(43) Pub. Date: Oct. 7, 2021

(54) PREFORM MADE OF POLYESTER

(71) Applicant: ALPLA WERKE ALWIN LEHNER GMBH & CO. KG, Hard (AT)

(72) Inventor: Daniel Goldenstein, Lochau (AT)

(21) Appl. No.: 17/265,518

(22) PCT Filed: Jul. 29, 2019
(86) PCT No.: PCT/EP2019/070377

§ 371 Date: Feb. 2, 2021

(30) Foreign Application Priority Data
Aug. 2, 2018 (CH) 00947/18

(51) Int. Cl. C08G 63/672; B29B 11/08; B29B 11/14; B29C 49/00; B29C 49/06; B65D 1/02; C08G 63/199

(52) U.S. Cl. CPC C08G 63/672; B29B 11/08; B29B 11/14; B29K 2067/003; B29C 49/06; B65D 1/0207; C08G 63/199; B29C 49/0005

(57) ABSTRACT

The invention relates to a preform made of polyester for producing a plastic container in a blow molding process which comprises a tube-like preform body which is closed at its one longitudinal end and at its other longitudinal end has a neck section provided with an opening for pouring. The polyester is based substantially on furandicarboxylic acid and diols, wherein the diols are derived partly from the group of spiro compounds and partly from the group of conventional diols.

### CROSS-REFERENCE TO RELATED APPLICATIONS

This application is a national phase entry under 35 U.S.C. § 371 of PCT/EP2019/070377 filed Jul. 29, 2019, which claims priority to Swiss Patent Application No. 00947/18 filed Aug. 2, 2018, the entirety of each of which is incorporated by this reference.

### FIELD OF THE INVENTION

The invention relates to a preform made of polyester for producing a plastic container in a blow molding process and a process for producing a preform.

### PRIOR ART

In the packaging sector, the market share of polyesters is constantly increasing. In addition to conventional materials such as polyethylene terephthalate (PET for short) and its copolyesters, bio-based polyesters such as polyethylene furanoate (PEF for short) will also establish themselves on the market in the future.

These polyesters have many advantages over other groups of plastic: They can be made from renewable raw materials in part or in case of PEF completely, have a very good recyclability (assuming no additives/dyes harmful to recycling are added) and create design benefits due to the intrinsic transparency of the material that other plastics are unable to achieve.

In addition, containers made of polyesters are on the market not only in the form of disposable packaging, but also as reusable packaging. Compared to glass, for example, enormous weight savings and advantageous mechanical properties (e.g., no splintering) are obtained. The energy requirement for the production of containers made of polyesters is significantly lower than for glass production.

The production of plastic containers often takes place in 2 stages: First, a preform is produced in the injection molding process. This preform is then heated beyond its glass transition point and inflated to form a bottle.

The first process of preform production is a primary shaping process. During this process, the melt has to be rapidly cooled so that crystallization is inhibited and the material freezes amorphously.

During said cooling, or later after inflating the preform to form a bottle and cooling of the bottle, so-called internal stresses can be frozen in the material especially near the injection point, said internal stresses often leading to stress cracking later on.

This is due to the inhomogeneity of the material. Areas of low molecular density and areas of high molecular density are present in the material, with crack formation mainly being initiated in the area of low molecular density. The inflation process of the preform to form the finished container generates additional stresses in the material, which increase the risk of stress cracking. Additional stresses due to internal pressure in the container (e.g., in case of carbonated beverages, aerosols, etc.), especially in containers with a volume greater than 1.5 l, and external influences such as, for example, contact with chemicals (especially alkalis) intensify or accelerate the formation of cracks. This crack formation is particularly greatly accelerated by detergents, aromatics such as aldehydes, ketones and short carboxylic acids and solvents such as acetone and ammonia. The filling of many detergents, cosmetics, window cleaners, paints and coatings in containers made from polyesters is often impossible for this reason.

The process of cracking is often referred to as Environmental Stress Cracking (ESC), and the resistance of a material to this process is therefore referred to as Environmental Stress Cracking Resistance (ESCR). If a material has a poor ESCR, the container can break. Depending on the internal pressure, the expansion of the crack can even lead to an explosion.

The ester bond can also be identified as a further explanation for the behavior described above: Due to environmental influences or contact with chemicals (e.g., through alkalis such as NaOH), saponification of the ester is possible, which is noticeable in the form of hydrolysis or chain cleavage in the material and is reflected by deteriorated material properties. Failure of the container is accelerated by the saponification reaction.

While the problems listed above arise where containers are made of polyesters (e.g., disposable bottle), reusable packaging in particular is exposed to an additional risk: After it has been used and before it is placed on the market again, reusable packaging is subjected to an intensive washing process, which is carried out at high temperatures (sometimes up to 75° C.) and using aggressive chemicals (washing lyes). Often, this increased stress manifests in a haze of the bottle, this optical phenomenon being caused by a plurality of very small microcracks. These microcracks make the material brittle and lead to the formation of macrocracks and thus to container failure later on.

### ADVANTAGES OF THE INVENTION

The disadvantages of the prior art described are addressed by the present invention in order to reduce the tendency for cracking in containers made of polyesters.

### DESCRIPTION

Preforms made of polyester are used to produce a plastic container in a blow molding process. The preform (in German: Vorformling) is mostly formed in the injection molding process into a tube-like preform body which is closed at its one longitudinal end and at its other longitudinal end has a neck section provided with an opening for pouring.

The present invention provides a preform made of polyester for producing a plastic container in that the polyester is based substantially on furandicarboxylic acid and diols, wherein the diols are derived partly from the group of spiro compounds and partly from the group of conventional diols. The polyester of the preform therefore consists substantially of a furandicarboxylic acid and a component selected from the group of spiro compounds and conventional diols and a combination thereof.

Surprisingly, this composition of the polyester makes it possible that the polyester can be partly bio-based and at the same time the tendency of the plastic container made from said preform to crack is greatly reduced. Said reduced cracking can be achieved by adding the spiro compound. In the context of this application, a spiro compound is understood to mean a polycyclic organic compound, the rings of which are connected at only one atom. The atom to which the neighboring rings are connected is called the spiro atom. The spiro atom acts as a kind of joint between the neighboring rings, which means that the rings remain flexible and movable with respect to one another. As a result of the connection between the polyester molecules and the spiro compounds, the polyester molecules have increased mobility or flexibility. This allows stresses in the molecular structure to be reduced or attenuated.

In addition to increasing the mobility of the molecular chains, the ester bond can be protected against nucleophilic attacks by inserting a spiro compound because the ester bond is sterically protected by the spiro compound. The attack of alkalis, especially the hydroxide ions thereof, which are used when washing reusable containers, can therefore be prevented by adding spiro compounds to the polyester.

In one embodiment of the invention, the group of conventional diols comprises monoethylene glycol, diethylene glycol, propylene glycol or butylene glycol. Therefore, the preform can be produced from different polyesters or copolymers, as a broad range of diols is suitable to be reacted with furandicarboxylic acid to form polyester and said polyester being suitable for spiro compounds to be incorporated into the polymer structure.

It has proven to be expedient if the proportion of the spiro compound is at least 1 or at least 2 percent by weight, the percentages by weight being based on the total weight of the preform. Even adding a small amount of spiro compounds or spiro-based monomer to the polyester will result in a significant improvement in the ESCR. For example, the following test method (Standard ISBT Stress Cracking Test) can be applied to determine the ESCR of a polyester container: The container is filled with water so that it contains its nominal volume of water. The container must then be pressurized to 77 +/− 0.5 psi and sealed. The water level is to be marked on the container. Subsequently, the container must be placed into a bath of 0.2 wt % sodium hydroxide solution. The sodium hydroxide solution must cover the entire container bottom. The time to failure of the container is a measure of the stress cracking resistance. Failure can be caused by an explosion of the container or a leak. The leak can be recognized by the fact that the level of the water in the container decreases or the internal pressure decreases. The standard ISBT Stress Cracking Test is especially suitable to determine the ESCR of plastic bottles made of polyester.

An experiment according to the standard ISBT Stress Cracking Test has shown that it takes almost twice as long for a polyester bottle made of polyester mixed with 4 wt % of spiro compounds to fail, compared to a polyester bottle that does not contain any spiro compounds. The polyester bottle, which contains 4 wt % of spiro compounds, fails after 70 minutes. A comparative polyester bottle, which, except for the spiro compounds, is identical in material and shape, fails after only 40 minutes. This experiment proves that the addition of the spiro compounds makes the polyester bottle more resistant or the polyester bottle can withstand greater stress caused by chemical contact, environmental influences and/or internal pressure.

In a further embodiment of the invention, the proportion of the spiro compound is between 1 and 35 percent by weight, between 2 and 10 percent by weight or between 3 and 5 percent by weight, the percentages by weight being based on the total weight of the preform. Depending on the expected stress on the polyester container made from the preform, the proportion of spiro compounds can be increased in order to prevent cracking and the associated failure of the container. The formation of stress cracks, which, as described above, inevitably occurs during the deformation from the preform to the polyester container, can be significantly reduced by providing the spiro compounds.

In another embodiment, the spiro compound is 3,9-bis(1,1-dimethyl-2-hydroxyethyl)-2,4,8,10-tetraoxaspiro[5.5]undecane (spiroglycol). Other spiro compounds are also perfectly suited to protect the ester bond sterically by their methyl and ethyl groups.

The specific spiro-based polyester is expediently a copolyester based on PEF, PPF or PBF. Therefore, the preform or the container may be bio-based and at the same time has the advantages resulting from the addition of the spiro compounds. It is irrelevant in this context whether the polyester or the container is colored, coated or textured. PPF is the abbreviation for polypropylene furanoate and PBF is the abbreviation for polybutylene furanoate. The polyester may be a copolymer with polyethylene furanoate, polypropylene furanoate or polybutylene furanoate as the first monomer units and spiro diol as the second monomer unit.

It has proven to be advantageous if the preform body has a wall thickness that is between 1 mm and 16 mm. The provision of the spiro compound in the polyester enables to produce very thick preforms, which, despite the thickness, hardly indicate any crystallization effects or become blurry at the slow cooling. These preforms are intended for polyester containers, which can replace glass containers. In doing so, polyester containers can be produced the properties of which correspond to the positive properties of glass containers, such as, for example, stability and reusability.

In a further embodiment of the invention, the preform is formed to form a reusable container. The reusable container is resistant to aggressive chemicals which usually have to be used for hygienic reasons before the reusable container is placed on the market again. The spiro compounds protect the ester bonds and prevent them from being weakened by saponification reactions. Such saponification reactions take place, for example, between polyesters and alkalis which are used in the cleaning of reusable containers.

Another aspect of the invention relates to a polyester container made of a preform according to the above description, the container having a spiro compound and withstanding more than 30 min in the standard ISBT Stress Cracking Test with a 0.2% alkali. These resistance values show that a polyester container containing spiro compounds can withstand high stresses in terms of chemical attack and/or internal pressure. Thus, the polyester container according to the invention can not only withstand cleaning with chemicals without any cracking appearing—it is also suitable for filling detergents, aromatics and solvents that attack and destroy conventional polyester containers.

In a further embodiment of the invention, the container is formed in such a way that it is suitable for refilling or as a reusable bottle. The chemicals required for cleaning, in particular alkalis, in order to be able to refill the container, do not attack the polyester or only to a limited extent, since the ester bonds of the polyester are protected from chemical attack by the spiro compounds.

In a further embodiment of the invention, the container is formed in such a way that it can withstand an internal pressure of up to 3 bar, up to 5 bar or up to 12 bar after filling, and is therefore suitable for filling carbonated beverages or aerosols. The spiro compounds reduce cracking, making the polyester container so stable that it can withstand internal pressures of up to 12 bar. It can therefore not only accommodate pressure-forming liquids, but can also be formed as an aerosol can. Further, it is suitable for a filling volume exceeding 1.5 liters, and to contain a carbonated liquid exceeding 1.5 liters.

The container is formed in such a way that it withstands temperatures between −19° C. and 96° C. and is therefore suitable for a filling process of container contents with a temperature between −19° C. and 96° C. The provision of the spiro compound in the polyester also has the result that the glass transition temperature of the polyester is increased. This makes the container suitable for hot filling of products and pasteurization of the container contents directly in the container.

In a process for producing a preform, a mixture of polyester plastic granules is prepared, the polyester being produced substantially from a furandicarboxylic acid and diols and a preform being produced from the mixture by injection molding. According to a further aspect of the invention, during the polymerization of the polyester a spiro compound is added to it, or the spiro compound is added to the polyester plastic granules during melting prior to injection molding and the mixture, after the addition of said spiro compound, contains a proportion of the spiro compound of at least 1, or at least 2 percent by weight, the percentages by weight being based on the total weight the mixture.

The copolymerization of the Spiro compounds in the required amount can be carried out simply and quickly by transesterification, since no additional process step is necessary. Rather, the Spiro compound may be introduced in a polyester without spiro diols using a second polyester having a high concentration of spiro diols by transesterification, and added during existing process steps, namely the polymerization of the polyester or the melting of the plastic granules. It has been found that the spiro compound, during polymerization or melting of the polyester, forms a homogeneous bond with the polyester and the modified polyester can meet the functional requirements described above very well.

It proves to be advantageous if the proportion of spiro compound contains between 1 and 35 percent by weight, between 2 and 10 percent by weight or between 3 and 5 percent by weight, the percentages by weight being based on the total weight of the mixture. By choosing the amount of the spiro compounds, the required functional properties of the polyester container can be set such that the requirement profile with regard to chemical resistance, temperature resistance and pressure resistance can be satisfied.

The invention also relates to a copolymer for producing a preform made of a polyester, wherein the polyester is produced substantially from a furandicarboxylic acid and diols and a spiro compound, wherein the proportion of the spiro compound is at least 1 or 2 percent by weight, the percentages by weight being based on the total weight of the copolymer. The copolymer therefore comprises polyethylene furanoate, polypropylene furanoate or polybutylene furanoate as the first monomer units and a spiro compound as a second monomer unit. The functional properties of the preform or polyester container produced from the copolymer can therefore be achieved with a relatively small amount of spiro compounds. To produce the preform mixture, the spiro compound can be added to the polyester during its polymerization or the melting for injection molding of the preform.

A final aspect of the invention relates to plastic granules for producing a preform made of polyester wherein the polyester is produced substantially from a furandicarboxylic acid and diols and a spiro-compound, wherein the proportion of the spiro compound is at least 1 or 2 percent by weight, the percentages by weight being based on the total weight of the plastic granules. If the plastic granules contain the spiro compounds, said spiro compounds are incorporated into the structure of the polyester during its polymerization. The intrinsic viscosity (IV) of the plastic granules is greater than or equal to 0.5 and less than or equal to 1.5 dl/g, measured in analogy to the test standard ASTM D4603. Measured in analogy to the test standard ASTM D4603 is understood to mean that the test standard ASTM D4603, which only applies to PET, is to be applied to a test specimen which is substantially produced from a furandicarboxylic acid and diols and a spiro compound. Furthermore, the plastic granules are crystalline. Here, the crystallinity of the plastic granules is greater than 20%. Furthermore, the plastic granules do not adhere to one another at a drying temperature of greater than or equal to 130° C.

1. A preform made of a polyester for producing a plastic container in a blow molding process, comprising:
a tube-like preform body which is closed at its one longitudinal end and at its other longitudinal end has a neck section provided with an opening for pouring, wherein the polyester is based substantially on furandicarboxylic acid and diols, and wherein the diols are derived partly from at least one spiro compound of a group of spiro compounds and partly from at least one conventional diol of a group of conventional diols.

2. The preform according to claim 1, wherein the at least one conventional diol comprises monoethylene glycol, diethylene glycol, propylene glycol or butylene glycol.

3. The preform according to claim 1, wherein a proportion of the at least one spiro compound is at least 1 percent by weight, the percent by weight being based on a total weight of the preform.

4. The preform according to claim 1, wherein a proportion of the at least one spiro compound is between 1 and 35 percent by weight, the percent by weight being based on the total weight of the preform.

5. The preform according to claim 1, wherein the at least one spiro compound is 3,9-bis(1,1-dimethyl-2-hydroxyethyl)-2,4,8,10-tetraoxaspiro[5.5]undecane (spiroglycol).

6. The preform according to claim 1, wherein the polyester is a copolyester based on PEF, PPF or PBF.

7. The preform according to claim 1, wherein the preform body has a wall thickness between 1 mm and 16 mm.

8. The preform according to claim 1, wherein the preform is formed to form a reusable container.

9. The preform according to claim 1, wherein the preform is formed into a polyester container, and wherein said container has a spiro compound and withstands more than 30 min in a standard ISBT stress cracking test with a 0.2% alkali.

10. The preform according to claim 9, wherein the container is formed in such a way that it is suitable for refilling or as a reusable bottle.

11. The preform according to claim 9, wherein the container is formed in such a way that it withstands an internal pressure after filling of up to 3 bar and thereby is suitable for the filling of carbonated beverages or aerosols.

12. The preform according to claim 9, wherein the container is formed in such a way that it withstands temperatures between −19° C. and 96° C. and thereby is suitable for a filling process of container contents with a temperature between −19° C. and 96° C.

13. A process for producing a preform, comprising:
preparing a mixture of polyester plastic granules, wherein said polyester plastic granules are made substantially of a furandicarboxylic acid and diols; and
producing a preform by injection molding from said mixture; and
adding a spiro compound to the polyester during polymerization of the polyester or adding the spiro compound to the polyester plastic granules during melting prior to injection molding, the mixture, after the addition of said spiro compound, contains a proportion of the spiro compound of at least 1 percent by weight, the percent by weight being based on a total weight the mixture.

14. The process according to claim 13, wherein a proportion of said spiro compound contains between 1 and 35 percent by weight, the percentages by weight being based on the total weight of the mixture.

15. A copolymer for producing a preform made of polyester, wherein the polyester is produced substantially from a furandicarboxylic acid and diols and a spiro compound, wherein a proportion of the spiro compound is at least 1, the percent by weight being based on a total weight of the copolymer.

16. The copolymer according to claim 15, wherein the proportion of the Spiro compound is between 1 and 35 percent by weight, the percent by weight being based on the total weight the copolymer.

17. The copolymer according to claim 15, wherein the Spiro compound is 3,9-bis(1,1-dimethyl-2-hydroxyethyl)-2,4,8,10-tetraoxaspiro[5.5]undecane (spiroglycol).

18. Plastic granules for producing a preform made of polyester, wherein the polyester is made substantially of a furandicarboxylic acid and diols and a spiro compound, and wherein a proportion of the spiro compound is at least 1 percent by weight, the percentages percent by weight being based on the a total weight of the plastic granules.

19. The plastic granules according to claim 18, wherein the proportion of the spiro compound is between 1 and 35 percent by weight the percent by weight being based on the total weight of the plastic granules.

20. The plastic granules according to claim 18, wherein the spiro compound is 3,9-bis(1,1-dimethyl-2-hydroxyethyl)-2,4,8,10-tetraoxaspiro[5.5]undecane (spiroglycol).

21. The plastic granules according claim 18, wherein an intrinsic viscosity is greater than or equal to 0.5 and less than or equal to 1.5 dl/g, measured in analogy to the a test standard ASTM D4603.

22. The plastic granules according to claim 18, wherein the plastic granules are crystalline.

23. The plastic granules according to claim 22, wherein a crystallinity of said plastic granules is greater than 20%.

24. The plastic granules of claim 18, wherein the plastic granules do not adhere to one another at a drying temperature of greater than or equal to 130° C.
